(19) United States
(12) Patent Application Publication
(10) Pub. No.: US 2025/0096321 A1
(43) Pub. Date: Mar. 20, 2025

(54) HIGH-VOLTAGE LITHIUM-ION BATTERY WITH A WIDE ELECTROCHEMICAL WINDOW OF POLYMER ELECTROLYTES

(71) Applicant: City University of Hong Kong, Hong Kong (HK)

(72) Inventors: Chunyi ZHI, Hong Kong (HK); Yue HOU, Hong Kong (HK)

(21) Appl. No.: 18/468,736

(22) Filed: Sep. 17, 2023

(51) Int. Cl. H01M 10/0565; H01M 4/131; H01M 4/134; H01M 4/66; H01M 10/0525

(52) U.S. Cl. CPC H01M 10/0565; H01M 4/131; H01M 4/134; H01M 4/661; H01M 10/0525

(57) ABSTRACT

The present invention relates to a PVTF-based solid polymer electrolyte, comprising: a polymer matrix; a N,N-Dimethylformamide (DMF) solvent; and a lithium bis(trifluoromethanesulfonyl)imide (LiTFSI). The PVTF-based solid polymer electrolyte demonstrates an exceptional electrochemical window of up to 5.68 V, a significantly higher ionic conductivity of 1.91×10⁻³ S cm⁻¹ at ambient temperature, and the PVTF-based solid polymer electrolyte has a glass transition temperature (T_{g}) lower than −38° C.

### FIELD OF THE INVENTION

The present invention generally relates to the field of solid-state lithium-ion battery technology, more specifically, the present invention provides a method for widening an electrochemical window of polymer electrolytes in high-voltage lithium-ion batteries.

### BACKGROUND OF THE INVENTION

Solid-state batteries transform easily flammable liquid electrolytes into non-combustible solid electrolytes, exhibiting enhanced stability in terms of mechanical and chemical properties. They also notably extend static and cycling lifespans. In contrast to the energy density of 250 Wh/kg in traditional lithium batteries, the energy density of solid-state batteries currently approaches 400 Wh/kg, offering significant advantages.

The solid-state lithium-ion battery (SSLIB) holds significant promise in meeting the substantial demand for advanced power supply systems. It has the potential to address the energy density, rapid charging, and safety prerequisites of upcoming consumer electronics and electric vehicles. The excellent mechanical property, high thermal resistance, and solvent-free/less feature of solid polymer electrolytes (SPEs) ensures its high security¹⁻³. Manufacturing the SPEs is an efficient protocol for pursuing improved safety and higher energy density in lithium-ion batteries (LIBs).

The SPEs possess enhanced processability for large-scale manufacturing compared to their solid ceramic electrolyte (SCEs) counterparts. This is attributed to their benign interfacial contacts with solid electrodes, and good mechanical flexibility⁴⁻⁶. Most polymers can be compatible with relatively low-voltage cathodes. However, only a few SPEs possess sufficient oxidation potential to pair effectively with high-voltage cathode materials. In the presence of aggressive cathodes such as 4.4 V LiNi_{0.8}Mn_{0.1}Co_{0.1}O₂ (NMC811) or 5.0 V LCPO, the carbonyl groups demonstrate anodic instability, with a thermodynamic propensity to release CO₂ and O₂. Consequently, cells comprised of Li∥NMC811 and Li∥LCPO exhibit notably inadequate performance.

Another challenge arises from the instability of Ni-rich cathodes. The lack of compatibility between SPEs and Ni-rich cathodes at higher potentials (potentials exceeding 4.5V) presents a challenge in the pursuit of further enhancing the energy density of SSLIBs⁷⁻⁸, resulting in SPE oxidation, cathode surface reconstruction, and dissolution of transition metal ions. Consequently, this leads to poor cycling performance⁹.

The above challenges make it difficult to further enhance the energy density of solid-state lithium-ion batteries (SSLIBs).

### SUMMARY OF THE INVENTION

Accordingly, the present invention introduces a novel strategy in the research of SPEs for the advancement of high-voltage SSLIBs. In particular, the present invention provides an approach to widen the electrochemical window of SPEs.

In a first aspect, the present invention provides a PVTF-based solid polymer electrolyte, comprising: a polymer matrix; a N, N-Dimethylformamide (DMF) solvent; and a lithium bis(trifluoromethanesulfonyl)imide (LiTFSI). The PVTF-based solid polymer electrolyte demonstrates an exceptional electrochemical window of up to 5.68 V, a significantly higher ionic conductivity of 1.91×10⁻³ S cm⁻¹ at ambient temperature, and the PVTF-based solid polymer electrolyte has a glass transition temperature (T_{g}) lower than −38° C.

In accordance with one embodiment, the polymer matrix comprises PVTF with a mass of 0.1 g to 2 g, the LiTFSI has a mass of 0.1 g to 2 g and the DMF solvent has a volume of 1-10 mL

In accordance with one embodiment, the PVTF-based solid polymer electrolyte further comprises a sacrificial additive.

In accordance with one embodiment, the sacrificial additive comprises lithium difluorophosphate (LiDFP) with a mass of 0.01-0.05 g.

In a second aspect, the present invention provides a high-voltage solid-state lithium-ion battery with a wide electrochemical window of polymer electrolytes, comprising: a cathode material; an anode material; a solid polymer electrolyte. The high-voltage solid-state lithium-ion battery has a consistent cycling performance over 200 cycles at 0.5 C, along with an impressive high-capacity retention of 75%.

In accordance with one embodiment, the cathode material comprises Ni-rich cathode material or lithium foil.

In accordance with one embodiment, the Ni-rich cathode material comprises spinel LiNi_{0.5}Mn_{1.5}O₄(LNMO) particles.

In accordance with one embodiment, there is an amorphous conductive CBI layer that encapsulates LNMO particles.

In accordance with one embodiment, the CEI layer comprises an inner CEI and an outer CEI, and wherein the inner CEI comprises Li₃PO₄ and LiF.

In accordance with one embodiment, the cathode comprising LNMO particles with the CEI layer exhibits improved rate performance, yielding respectable specific capacities of 137, 130, 125, 105, and 70 mAh g⁻¹ recorded at 0.1, 0.2, 0.5, 1.0, and 2 C, respectively.

In accordance with one embodiment, the anode material comprises lithium foil.

In accordance with one embodiment, the anode and cathode further comprise a current collector, one or more active materials, one or more electronic conductive particles and one or more binders.

In accordance with one embodiment, the current collector comprises aluminum foil or copper foil.

In accordance with one embodiment, the high-voltage solid-state lithium-ion battery has a stable cycling lifespan of approximately 2400 hours at a current density of 0.1 mA cm⁻² with a capacity of 0.1 mAh cm⁻², demonstrating a very low overpotential of 55.7 mV.

In accordance with one embodiment, the high-voltage solid-state lithium-ion battery achieves a long cycle life of approximately 1600 hours when the current density increased to 0.5 mA cm⁻².

The present invention uses a poly(vinylidene fluoride-co-trifluoroethylene-co-chlorotrifluoroethylene) [(PVDF-TrFE-CFE)] (denoted as PVTF) polymer with high oxidation stability as the SPE matrix according to the highest occupied molecular orbital (HOMO) energy level and a sacrificial additive (lithium difluorophosphate, LiDFP) for stabilizing the LiNi_{0.5}Mn_{1.5}O₄ (LNMO) cathode. Compared to existing technologies, the present invention offers the following major advantages:
(1) The PLSE separator exhibits significantly enhanced electrochemical stability compared to PSE, thereby enabling the reversible operation of lithium-ion batteries.
(2) The design strategy for PLSE is more cost-effective and user-friendly, because a free-standing PLSE can be obtained through the casting and blade coating process, which simplifies the acquisition of solid electrolytes for Li-ion batteries (LIBs) compared to the conventional assembly method involving immersing the separator in liquid electrolytes.
(3) The PLSE demonstrates an exceptional electrochemical window of up to 5.68 V, which surpasses the capabilities of existing SPE technology.
(4) The PLSE finds extensive utility across various types of lithium-based batteries, and it demonstrated high safety properties when compared to conventional liquid LIBs.

### BRIEF DESCRIPTION OF THE DRAWINGS

Embodiments of the present invention are described in more detail hereinafter with reference to the drawings, in which:

FIG. 1A depicts redox potential of cathode materials for Li-ion batteries and electrochemical stability window of conventional solid polymer electrolytes. FIG. 1B shows a schematic illustration of the severe issues existing in the Ni-rich oxide electrode materials. FIG. 1C shows a schematic energy diagram of a polymer electrolyte. E_{g} is the energy separation of highest occupied molecular orbital (HOMO) and lowest unoccupied molecular orbital (LUMO) of polymer electrolyte;

FIG. 2A shows a scheme representative of the HOMO and LUMO level of PEO, PVTF, PMMA, PAN, and PVDF. FIG. 2B shows a schematic illustration of the PVTF polymer structure;

FIG. 3 depicts FTIR patterns of the PVTF and PVDF polymers;

FIG. 4 depicts strain-stress curves of different SPEs;

FIGS. 5A-5D depict EIS patterns at different temperatures ranging from 25 to 100° C. FIG. 5E depicts the corresponding ionic conductivities of the fabricated PSEs with the weight ratio of LiTFSI/P(VDF-TrFE-CFE) varying from 0.1 to 1.5;

FIG. 6 shows diagram of the cathode-electrolyte interphase (CEI) formation during the charge-discharge process for PLSE;

FIG. 7A depicts linear sweep voltammetry (LSV) measurements of the LNMO|PSE|Li and LNMO|PLSE|Li solid-state battery. FIG. 7B depicts arrhenius plots of the PSE and PLSE. σ is the ionic conductivity and T is the temperature. FIG. 7C depicts a comparison of the ionic conductivity and electrochemical window of the as-prepared SPE (at room temperature) with other works;

FIG. 8A shows a SEM image of the fabricated PLSE. FIG. 8B shows a cross-sectional SEM image of the fabricated PLSE;

FIG. 9 depicts DSC curves of the fabricated PSE and PLSE;

FIG. 10A depicts Tafel plots of the Li|PSE|Li and Li|PLSE|Li cells. FIG. 10B depicts chronoamperometry profiles of the Li|PLSE|Li cells under a polarization voltage of 20 mV. The inset is the EIS curves before and after the polarization. FIG. 10C depicts chronoamperometry profiles of the Li|PSE|Li cells under a polarization voltage of 20 mV. The inset is the EIS curves before and after the polarization. FIG. 10D depicts voltage profiles of the lithium plating/stripping cycling of the Li|PLSE|Li cell with a current density of 0.1 mA cm⁻² with the corresponding EIS patterns at different charge conditions. FIG. 10E depicts voltage profiles of the lithium plating/stripping cycling of the Li|PLSE|Li cell with a current density of 0.5 mA cm⁻² with the corresponding EIS patterns at different charge conditions. FIG. 10F depicts voltage profiles of the lithium plating/stripping cycling of the Li|PLSE|Li cell under different current densities;

FIG. 11 shows HRTEM image of LNMO cathode with PSE after 5 cycles at 0.5 C with corresponding inset showing the crystal plane of the LNMO, and the HRTEM image of the LNMO cathode with PLSE after 5 cycles at 0.5 C with the corresponding inset showing the thickness of CEI layer;

FIG. 12 shows. EDX-mapping images of LNMO cathode with PLSE after 5 cycles at 0.5 C;

FIG. 13 shows 3D ToF-SIMS of the surface for C₂HO⁻, PO₂F₂, PO₂F⁻, OH⁻, NiO⁻, NiF⁻, PO₃⁻, LiF₂⁻, F on LNMO surface with PLSE at the end of 5th cycle;

FIGS. 14(a)-(i) show TOF-SIMS negative ion mapping-depth profiles of the surface for (FIG. 14(a)) C₂HO⁻, (FIG. 14(b)) PO₃⁻, (FIG. 14(c)) PO₂F⁻, (FIG. 14(d)) PO₂F₂⁻, (FIG. 14(e)) OH⁻, (FIG. 14(f)) F⁻, (FIG. 14(g)) NiO⁻, (FIG. 14(h)) NiF⁻, and (FIG. 14(i)) LiF₂⁻ on LNMO surface with PLSE at the end of 5^{th} cycle;

FIG. 15 depicts the depth profiles of several secondary ion fragments at the cycled LNMO surface by sputtering via ToF-SIMS;

FIG. 16 depicts XRD results of the LNMO cathodes at fresh states, cycled with PSE and PLSE after 5 cycles at 0.5 C;

FIG. 17A depicts XPS survey of the LNMO cathodes at fresh states, cycled with PSE and PLSE after 5 cycles at 0.5 C. FIG. 17B depicts Mn 2p of the LNMO cathodes at fresh states, cycled with PSE and PLSE after 5 cycles at 0.5 C. FIG. 17C depicts Ni 2p of the LNMO cathodes at fresh states, cycled with PSE and PLSE after 5 cycles at 0.5 C;

FIG. 18 depicts XPS C 1s, F 1s and P 1s spectra of the LNMO cathode surface with PSE and PLSE after 5 cycles at 0.5 C;

FIGS. 19(a)-(d) depict XPS survey, C 1s, F 1s and P 2p of the LNMO cathodes at fresh states, cycled with PLSE after 50 cycles at 0.5 C;

FIG. 20 shows chemical compositions of CEI layer obtained by quantitative XPS analyses including XPS survey results and the fitted XPS spectra;

FIG. 21 shows a proposed decomposition mechanism of LiDFP-containing PLSE at the Ni-rich cathode;

FIG. 22A depicts CV curves of LNMO|PLSE|Li cells at 0.5 mV s⁻¹. FIG. 22B depicts the rate performance at different rates of LNMO|PLSE|Li cells. FIG. 22C depicts the corresponding GCD curves of LNMO|PLSE|Li cells. FIG. 22D depicts cycling performance and CE of LNMO|PSE|Li cell and LNMO|PLSE|Li cell at 0.5 C. FIG. 22E shows a comparison of the cycle lifespan between the present invention with prior arts;

FIG. 23 depicts CV curves of LNMO|PSE|Li cells at 0.5 mV s⁻¹; and

FIG. 24 depicts selected GCD curves of LNMO|PLSE|Li cell at 0.5 C.

### DETAILED DESCRIPTION

The present invention will be described in detail through the following embodiments with appending drawings. It should be understood that the specific embodiments are provided for an illustrative purpose only, and should not be interpreted in a limiting manner. Those skilled in the art will appreciate that the invention described herein is susceptible to variations and modifications other than those specifically described.

The invention includes all such variation and modifications. The invention also includes all of the steps and features referred to or indicated in the specification, individually or collectively, and any and all combinations or any two or more of the steps or features. Other aspects and advantages of the invention will be apparent to those skilled in the art from a review of the ensuing description.

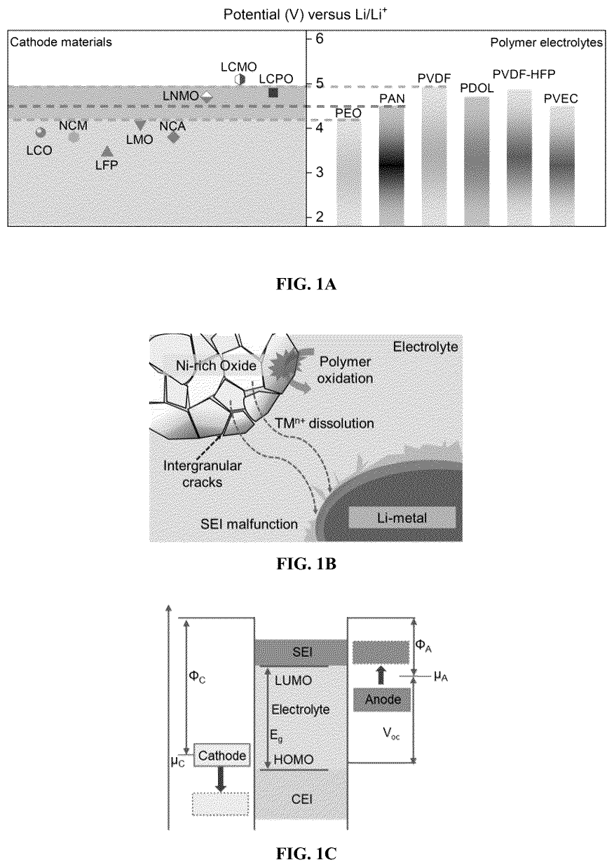

As observed in FIG. 1A, which presented the reported electrolyte stability window for various polymer electrolytes and potential electrode materials. The conventional solid polymer electrolytes include poly(ethylene oxide) (PEO), polyacrylonitrile (PAN), polyvinylidene difluoride (PVDF), polymerized 1,3-dioxolane (PDOL), poly(vinylidene fluoride-co-hexafluoropropylene) (PVDF-HFP), and Poly(vinyl ethylene carbonate) (PVEC). Most polymers could be compatible with relatively low-voltage cathodes, such as LiCoO₂ (LCO) or LiFePO₄ (LFP). However, only a few SPEs possessed sufficient oxidation potential to pair effectively with high-voltage cathode materials like LiNi_{0.5}Mn_{1.5}O₄ (LNMO), LiCoMnO₄ (LCMO), and LiCoPO₄ (LCPO).

Turning to FIG. 1B, which showed a schematic illustration of severe issues existing in the Ni-rich oxide electrode materials, such as interfacial side reactions, transition metal ions dissolution and intergranular cracks. The degradation of the high-voltage cells originates from the drastic reaction between oxidized polymer electrolytes and high-voltage cathodes, leading to the formation of surface deposits and undesirable phase changes within the cathodes. This can trigger the dissolution of transition metal ions (TMⁿ⁺) at the cathode-electrolyte interface, elevating the charge transfer resistance of the cathode and ultimately resulting in the deterioration of electrochemical performance during cycling. These factors hinder the operation of lithium-ion batteries assembled with high-voltage cathodes.

To mitigate the oxidation of polymer electrolytes and prevent ongoing interactions between the electrolytes and cathodes, it's imperative to broaden the inherent stability window of the polymer electrolyte. Past research efforts have been centered around the design of artificial solid-state electrolyte interphase (SEI) protective layers incorporating LiF, Li₃PO₄, or Li₃PS₄ onto Li metal surfaces in order to enhance interface compatibility.

However, there remain technical challenges to overcome, such as the considerably lower ionic conductivity of solid electrolytes compared to liquid electrolytes. This leads to a notable increase in the internal resistance of the battery, resulting in compromised battery cycle performance and rate capability. On the other hand, the high cost is also a factor restricting the commercialization of all-solid-state batteries.

In view of this, the present invention developed an environmentally friendly and user-friendly strategy to regulate the electrochemical window of SPEs. The present invention provides a PVTF-based solid polymer electrolyte, comprising: a polymer matrix; a N, N-Dimethylformamide (DMF) solvent; and a lithium bis(trifluoromethanesulfonyl)imide (LiTFSI). The PVTF-based solid polymer electrolyte demonstrates an exceptional electrochemical window of up to 5.68 V, a significantly higher ionic conductivity of 1.91×10⁻³ S cm⁻¹ at ambient temperature, and the PVTF-based solid polymer electrolyte has a glass transition temperature (T_{g}) lower than −38° C.

There are three components introduced into the PLSE, including PVTF polymer, lithium bis(trifluoromethanesulfonyl)imide (LiTFSI) and a sacrificial additive lithium difluorophosphate (LiDFP), which is used as the electrolytes for solid lithium-ion batteries. Through the utilization of the LiDFP to stabilize the decomposition of the LNMO cathode (referred to as PLSE), the electrochemical window of SPEs was effectively expanded to 5.68 V. The PVTF matrix, possessing the lowest HOMO energy level among the various SPEs, demonstrates its inherent antioxidant capacity, which can be well coupled with LNMO cathodes. This accomplishment has paved the way for the fabrication of a high-voltage Li∥LNMO cell, demonstrating remarkable cycling stability. This is evidenced by a consistent cycling performance over 200 cycles at 0.5 C, along with an impressive high-capacity retention of 75%, the Li∥LNMO cell featuring the engineered SPE shows remarkable performance.

In one of the embodiments, the anode material may be lithium foil.

In one of the embodiments, the cathode material may be Ni-rich cathode. The key factor in stabilizing Ni-rich cathodes is the polymer matrix with a high oxidation resistance capability.

In one of the embodiments, the sacrificial additive may be LiDFP.

Incorporating a cathode-electrolyte interlayer containing LiDFP can mitigate the gradual interaction issues within polymer electrolytes of non-aqueous Li-ion batteries. This approach addresses safety concerns while also lowering material and production expenses.

LiDFP was initially proposed as an electrolyte additive to improve the rate capability of graphite∥NMC cells¹⁰ and was found to improve the low-temperature performance of graphite∥NMC cells¹¹. Such behaviors were attributed to the reduction in interfacial impedance following the incorporation of LiDFP. It has been demonstrated that LiDFP is capable of producing a compact and thin cathode-electrolyte interphase (CEI) enriched with fluorophosphate¹².

It is necessary to search for a polymer matrix with a relatively low HOMO energy level in order to achieve stable operation of the Ni-rich oxide cathodes. However, the presence of salts, impurities, and interactions between the cathode surface and the electrolyte critically affects the redox potentials of the polymers. This can result in deviations as high as 4 eV from the HOMO energies (FIG. 1C). Therefore, potential side reactions between the electrodes and electrolytes should be prevented by constructing a compact and electron-insulating cathode-electrolyte interphase (CEI) on the cathodes.

In one of the embodiments, the pyrolysis of the salt produces an amorphous conductive CEI layer that encapsulates LNMO particles, thereby enhancing the kinetics of lithium-ion and electron transfer.

In the present invention, the construction of stable CEI layer comprising LiF and Li₃PO₄ on the LNMO cathodes proves advantageous for enhancing the cycling stability. Additionally, the elevated conductivity exhibited by the engineered PLSE significantly enhances the rate performance of high-voltage LNMO|SPE|Li cells.

In another embodiment, the establishment of a stable CEI on LNMO cathodes enhances rate performance, yielding respectable specific capacities of 137, 130, 125, 105, and 70 mAh g⁻¹ recorded at 0.1, 0.2, 0.5, 1.0, and 2 C, respectively.

In another embodiment, the cathodes with operating potentials below 5 V, including LiFePO₄, NCM 523, and NCM 811, are all compatible with the electrolyte of the present invention.

In one of the embodiments, as the temperature decreases from room temperature to about −196° C., both the tensile strength and ductility improve.

The following examples illustrate the present invention and are not intended to limit the same.

### EXAMPLE

### Example 1—Materials and Methods

### Materials

N-Methyl-2-pyrrolidone (NMP), N, N-Dimethylformamide (DMF), poly(vinylidene fluoride-co-trifluoroethylene-co-chlorotrifluoroethylene) (PVDF-TrFE-CFE), polyvinylidene difluoride (PVDF), poly(ethylene oxide) average Mv 400,000 PEO, lithium bis(trifluoromethanesulfonyl)imide (LiTFSI), spinel LiNi_{0.5}Mn_{1.5}O₄ (LNMO), lithium difluorophosphate (LiDFP) were all purchased from Aladdin.

### Characterization Methods

Fourier-transform infrared spectroscopy (FTIR) was collected based on the PerkinElmer Spectrum II. Raman spectra were detected on the WITec alpha300 R Raman System. Differential scanning calorimetry (DSC) experiments were conducted using a DSC Q2000 (TA Instruments) with Tzero pans. Thermogravimetric Analysis (TGA) was applied on TG/DTA 6300 to obtain the polymer content in the composite. A field-emission scanning electron microscope (SEM, FEI Quanta 450 FEG) was used to investigate the morphologies of the products. Powder X-ray diffraction (PXRD) was performed at ambient temperature on Bruker D2 Phaser equipment, using Cu-Kα radiation with a monochromator. ToF-SIMS analyses were performed with a 5-100 instrument (IONTOF GmbH) equipped with a 30 keV Bi₃⁺ primary ion gun and a 1 keV Cs⁺ sputter gun. The raster size of the image was 50×50 μm², and the sputtering area was 200×200 μm². The microstructure and chemical composition were detected by a field emission scanning electron microscopy, SEM (S-4700, Hitachi), high-resolution transmission electron microscopy (TEM; JEOL-2001F), and electron energy loss spectroscopy (EELS) analysis. X-ray photoelectron spectroscopy (XPS; ESCALAB 250) was employed to analyze the surface composition details with C 1s peak calibration at 284.8 eV. XPS spectra were recorded for O 1s, P 2p, F 1s, Li 1s and C 1s. The discharged/charged LNMO cathodes were gently washed with ethylene carbonate (EC) three times and then dried in the glove box at room temperature for 24 h before measurements.

### Electrochemical Measurement

The Ti∥Ti coin cell with the prepared SPE was assembled to measure the EIS.

The ionic conductivity could be calculated by using the following equation:

$$σ = L / ( A * R ) ,$$

where L represents the thickness of the polymer electrolytes, R represents obtained by the above EIS measurements, and S represents the area of stainless steel.

The Li|PLSE|Li symmetric batteries with the fabricated PLSE were conducted EIS measurements from 10 MHz to 0.01 Hz with a 20 mV AC oscillation. The transference number of cations including Lit could be calculated according to the following equation:

$${t}_{{Li}^{+}} = \frac{{I}_{s} ( Δ V - {I}_{0} {R}_{0} )}{{I}_{0} ( Δ V - {I}_{s} {R}_{s} )} ,$$

where Iₛ and I₀ represent the steady-state and initial currents, respectively, R₀ and Rₛ represent the interfacial resistance before and after polarization.

The electrochemical stability window of the SPE was determined by performing linear sweep voltammetry (LSV) measurements on assembled Li|SPE|Ti cells. All of these electrochemical properties were assessed using the CHI 760D electrochemical workstation. CR2032 coin cells were assembled, utilizing a Li foil as the anode, LNMO as the cathode, and either PLSE or PSE as solid polymer electrolytes (SPEs) for electrochemical assessments. All these cycling tests were conducted on the Land CT2001A battery testing system.

### Computational Calculation

The electronic structures were calculated by using Gaussian 6.0 software. The hybrid density functional B3LYP with the 6-31G* basis sets has been used for the structure optimization as well as the electronic structures calculation.

### Example 2—Evaluating the Polymer Matrix for the Ni-Rich Oxide Cathodes

To identify the most suitable polymer matrix for the Ni-rich oxide cathodes, Gaussian calculations were performed to determine the HOMO and LUMO energy levels of various polymers. The most widely used descriptors for electrolyte stability were the lowest unoccupied molecular orbital (LUMO) and highest occupied molecular orbital (HOMO) of the polymer matrix. A lower energy level of the HOMO represented higher oxidation stability of the polymer.

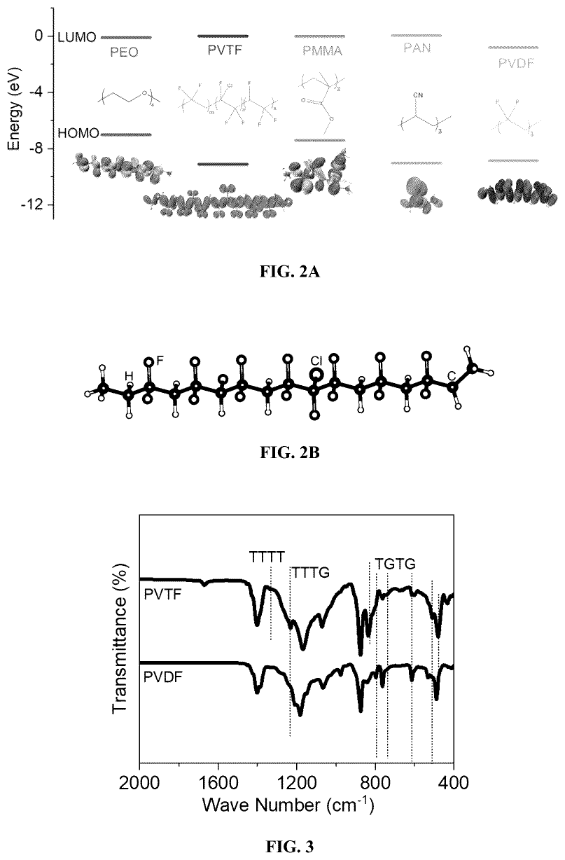

As shown in FIG. 2A, the PVTF exhibited the lowest energy level of the HOMO, indicating its highest oxidation stability among all the selected polymers, including PEO, PMMA, PAN, and PVDF. In the PVTF polymers, stable fluorine (F) atoms surrounded the carbon chain, forming a tight spatial barrier that ensured the stability of PVTF's internal structure (FIG. 2B).

Referring to FIG. 3, Fourier-transform infrared spectroscopy (FTIR) was employed to analyze the chain conformations of PVTF and PVDF. The PVTF displayed a hybrid sequence of random TGTG (where T represented trans and G stood for gauche), TTTG, and TTTT sequences¹³. The PVTF polymer contained a polar β-phase with an all-trans (TTTT) conformation, whereas no β-phases existed in the conventional PVDF polymer.

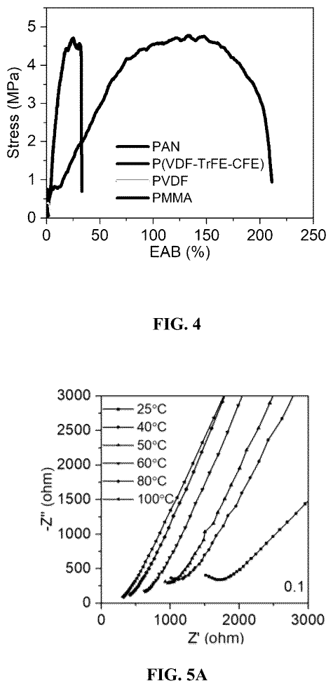

Turning to FIG. 4, when compared with other conventional polymers, the mechanical properties of the chosen polymers were also compared through stress-strain tests. The results show that PVTF exhibited the highest elongation (150%) along with the highest yield strength (4.8 MPa). Based on its high-voltage compatibility and mechanical strength, PVTF was chosen as the polymer matrix to fabricate SPEs for the Ni-rich oxide cathodes. The salt concentration of the PVTF-based SPE was optimized, and the corresponding SPEs were labeled as PVTFₓ (where x represented the weight ratio of lithium bis(trifluoromethanesulfonyl)imide (LiTFSI) to PVTF).

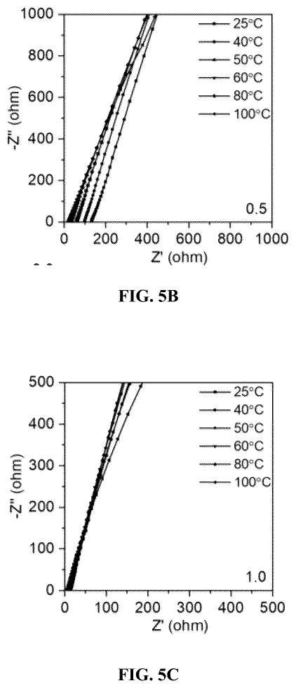

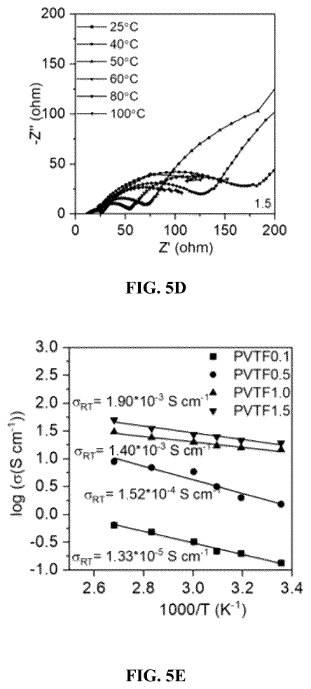

Furthermore, the TTTT conformation conferred high polarity to PVTF, allowing it to accommodate a significant salt content of up to 150%. The electrochemical impedance spectroscopy (EIS) results of PVTFₓ obtained under different temperatures ranging from 25 to 100° C. are depicted in FIGS. 5A-5D, and the corresponding ionic conductivities are summarized in FIG. 5E.

Both PVTF_{1.5} and PVTF_{1.0} exhibited relatively high ionic conductivities at room temperature, measuring 1.90 and 1.40 mS cm⁻¹, respectively. Nonetheless, the PVTF_{1.5} membrane experienced cracking issues during the cell assembly process. Considering mechanical strength, PVTF_{1.0} was chosen as the polymer matrix for subsequent modifications.

### Example 3—Preparation of PSE and PLSE Membranes

For the PSE membrane, PVDF-TrFE-CFE polymer (0.5 g) was added into a beaker containing 5 mL DMF, followed by dissolving LiTFSI (0.5 g) in the DMF solution. Then, the solution was stirred for 2 h and heated at 70° C. Finally, the transparent solution was dropped onto a glass plate and dried at 50° C. in an oven for 8 h to remove the residual DMF.

For the PLSE membrane, PVDF-TrFE-CFE polymer (0.5 g) was added into a beaker containing 5 mL DMF, followed by dissolving LiTFSI (0.5 g) and LiDFP (0.025 g) in the DMF solution. Then, the solution was stirred for 2 h and heated at 70° C. Finally, the transparent solution was dropped onto a glass plate and dried at 50° C. in an oven for 8 h to remove the residual DMF.

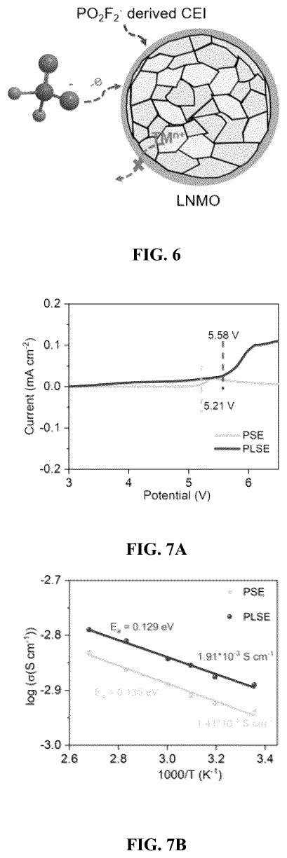

Hu et al. have proved robust interphase containing LiF and Li₃PO₄ was formed by LiDFP decomposition¹⁴. As depicted in FIG. 6, the protective interphase suppressed the dissolution of transition metals and cathode surface reconstruction. This suppression facilitated a uniform distribution of Li within the cathode, effectively mitigating strain and preventing crack formation.

### Example 4—Characterization of PSE and PLSE Membranes

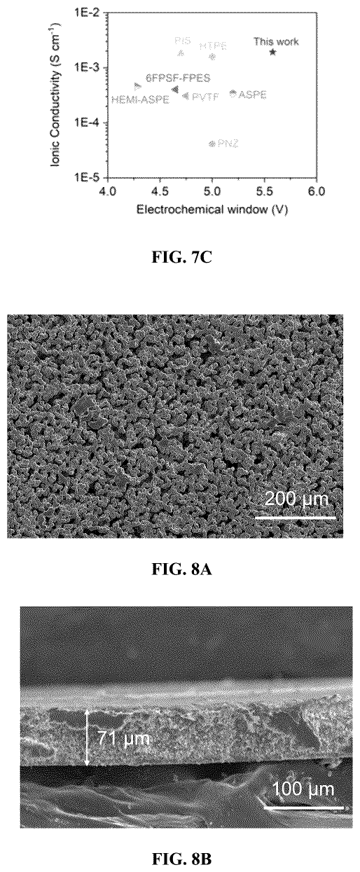

The electrochemical stability of the developed PVTF-based SPE without LiDFP (PSE) and PLSE was examined on the assembled Li∥Ti cell. The additive of LiDFP was sacrificed in advance to realize high voltage up to 5.58 V. Referring to FIGS. 7A-7C, the PLSE showed a significantly higher ionic conductivity of 1.91×10⁻³ S cm⁻¹ at ambient temperature and a much lower energy barrier (0.129 eV) than the PSEs (1.41×10⁻³ S cm⁻¹ at ambient temperature, 0.135 eV). Evidently, the PLSE exhibited the broadest electrochemical window and the highest ionic conductivity when compared to the previously reported works. This outcome resulted from the synergistic effect between LiDFP and PVTF.

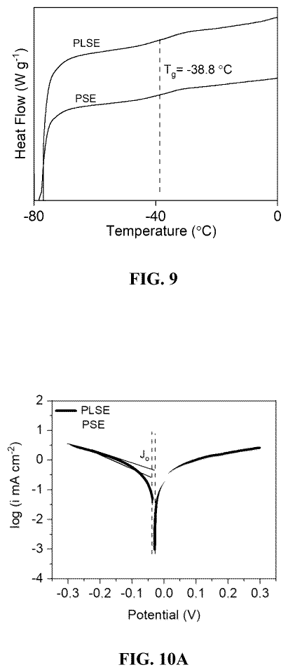

According to the SEM image shown in FIG. 8A, the PLSE displayed a dense morphology with pores of varying sizes, which were beneficial for ion transport. The thickness of PLSE was about 71 m in terms of the cross-sectional SEM image in FIG. 8B.

Additionally, as indicated by the differential scanning calorimetry (DSC) results of the SPEs (FIG. 9), both the PLSE and PSE showed a glass transition temperature (T_{g}) of around −38.8° C. This indicated that the PVTF polymer chain segments were able to move above −38.8° C., consequently achieving high ionic conductivity at room temperature.

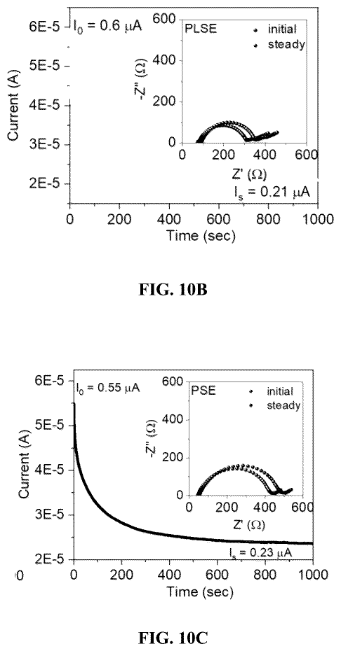

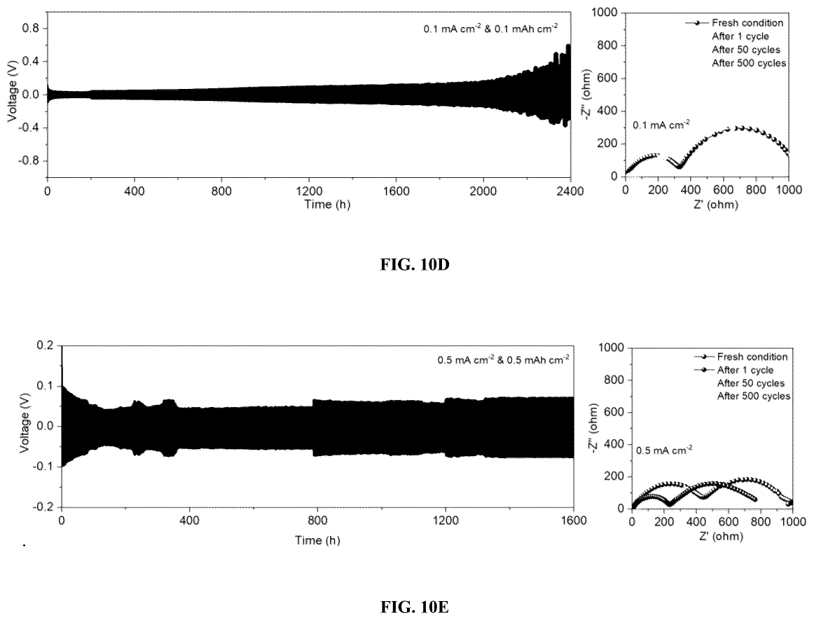

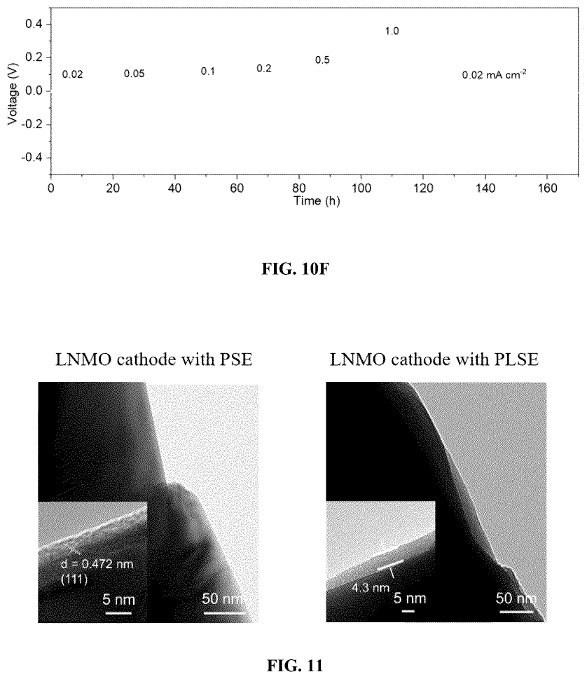

The ion-transfer kinetics at the interface enabled by PSE and PLSE can be elucidated through the exchange current density (i₀) tested using Li|SPE|Li symmetric cells. Referring to FIG. 10A, the i₀ value (2.14 mA cm⁻²) fitted with the Tafel plot of PLSE was larger than that of PSE (0.26 mA cm⁻²), indicating fast Li⁺-transfer kinetics. This feature of PLSE could extend to the Li⁺ transport kinetics in PLSE. The t_{Li+} was calculated by a method reported in the literature,²⁹ which was 0.5 (FIG. 10B) and 0.45 (FIG. 10C). The higher t_{Li+} and ionic conductivity of the PLSE ensured promoted Li⁺ transportation, which not only greatly enhanced ion mobility but also facilitated uniform diffusion and deposition of Li⁺.

### Example 5—Preparation of Li|PSE|Li Cells, Li|PLSE|Li Cells and LNMO|SPE|Li Cells

Li|PSE|Li and Li|PLSE|Li cells were assembled using a Li foil as the anode and the cathode, and PLSE or PSE as SPEs in the CR2032 coin cells for electrochemical measurements. LNMO|PSE|Li and LNMO|PLSE|Li cells were assembled using a Li foil as the anode and LNMO as the cathode, and PLSE or PSE as SPEs in the CR2032 coin cells for electrochemical measurements. All these assembling process were conducted in the glove box.

LNMO powder was coated on Al foil with 2 mg cm⁻² loading mass as the LNMO cathode (LNMO: PVDF: carbon black=8:1:1).

As shown in FIG. 10D, the Li|PLSE|Li symmetric cell had a stable cycling lifespan of 2400 hours at a current density of 0.1 mA cm⁻² with a capacity of 0.1 mAh cm⁻², demonstrating a very low overpotential of 55.7 mV. The interfacial resistance appeared to have decreased from 380 to 85Ω and remained stable during the 2400-hour cycle period. It was a strong testament of the intrinsic stability of Li anode rendered by the fabricated PLSE and rules out the possibility of the “soft shorts”. A long cycle life of 1600 h was also achieved when the current density increased to 0.5 mA cm⁻². Referring to FIG. 10E, the Li|PLSE|Li symmetric cell showed a low overpotential of 68 mV after 1600 hour cycling, further illustrating the cycling stability of the SPEs during Li⁺ transference. The corresponding EIS patterns were presented in right side of FIG. 10E, showing a decrease trend, and retained to a stable value of 120Ω during the 1600 h cycling. Meanwhile, cycling under different current densities from 0.02 to 1.0 mA cm⁻² was carried out, and the Li|PLSE|Li symmetric cell demonstrated marginally lower voltage hysteresis (FIG. 10F), confirming the high ionic conductivity of PLSE. The high ionic conductivity, good interfacial compatibility between the PLSE and electrodes, and the enhanced Li⁺-transfer kinetics of PLSE contributed to superior rate performance and long-cycling stability for Li∥Li symmetric cells.

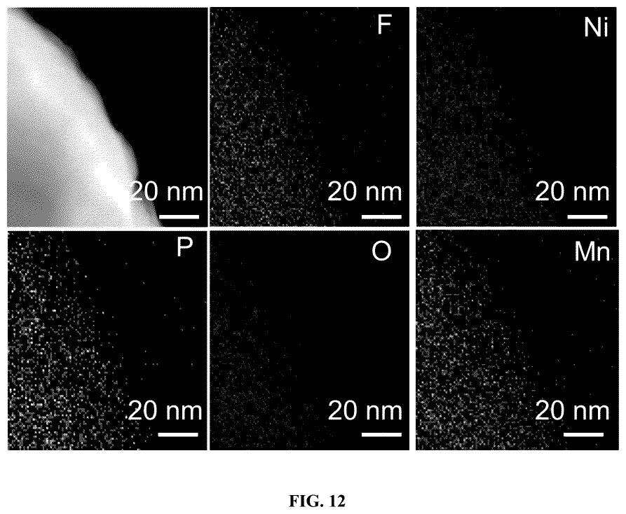

Moreover, high-resolution transmission electron microscopy (HRTEM) analysis was conducted to characterize the detailed interfacial structural features of the LNMO cathodes cycled with PSE and PLSE. Referring to FIG. 11, no CEI layer was observed in the LNMO cathode cycled with PSE. The inset presents high-resolution lattice fringes with an interplanar spacing of 0.472 nm, indicative of the (111) crystal plane of the LNMO cathode. In contrast, a thin protection layer with an average thickness of 4.5 nm was detected in the LNMO cathode cycled with PLSE, which is an amorphous phase in favor of ion transport in the subsequent electrochemical reactions. The uniform distribution of O, P, and F elements forcefully demonstrated the homogeneity and reliability of the artificial CEI strategy (FIG. 12).

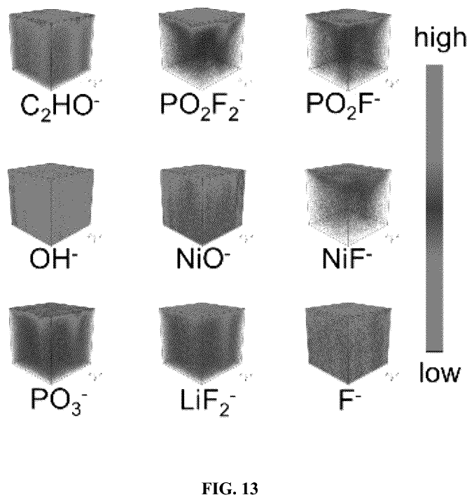

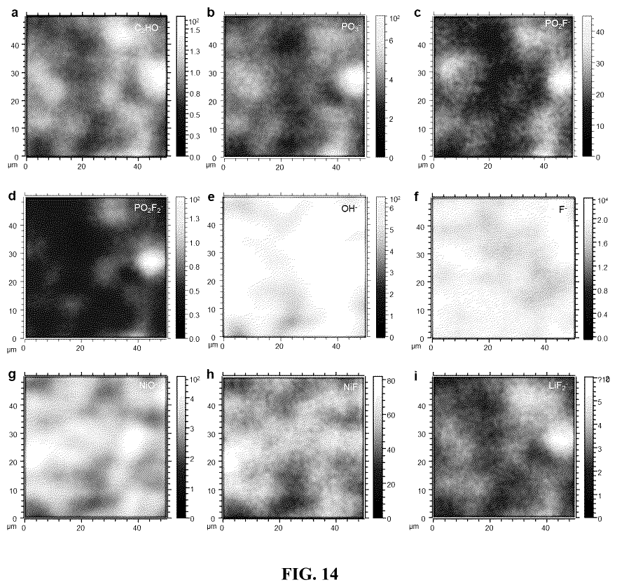

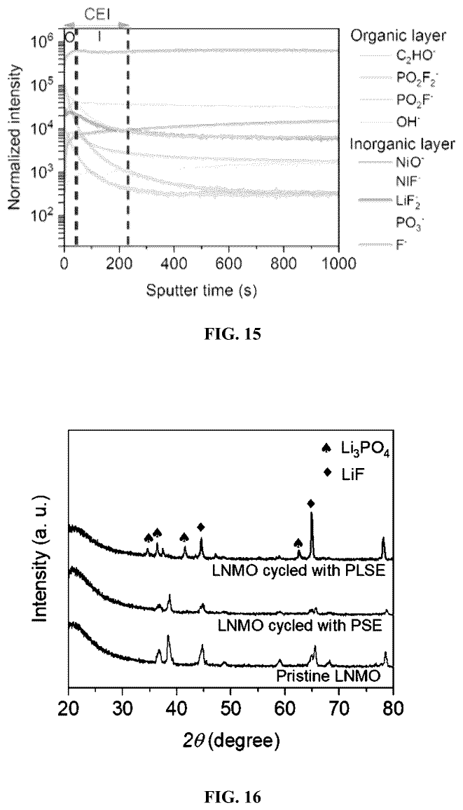

As shown in the FIG. 13 and FIGS. 14(a)-14(i), the time-of-flight secondary ion mass spectrometry (ToF-SIMS) chemical mappings that collected on LNMO cathode after the fifth cycle revealed that the interphase products, including inorganic species (represented by LiF₂⁻) and organic species (represented by OH⁻ and C₂HO⁻), appear at the LNMO particle surfaces. As shown in FIG. 15, the normalized depth profiles of ToF-SIMS revealed the complex multilayered characteristic of the CEI on LNMO surface region. As the sputter time progressed, the intensities of organic species (represented by OH⁻, CH₂⁻, and C₂HO⁻), such as ROLi and ROCO₂Li³², change from high to low, indicating that organic species mainly appear at the outer layer. However, the intensities of the inorganic constituents consisting of LiF and Li₃PO₄ changed from low to high. This revealed that the CEI on the LNMO surface consisted of an inner inorganic layer and an outer organic layer.

The LNMO|SPE|Li cells delivered superior capacity, exhibited good rate performance, and maintained stable cycling life. This strategy for widening the electrochemical window of SPEs could be widely utilized in lithium-based batteries, including lithium oxygen batteries and lithium sulfur batteries, which could greatly promote the development of various high-voltage lithium-based batteries.

### Example 6—CEI Components

To characterize the CEI components, X-ray diffraction (XRD) patterns of the CEI samples collected from the cells using PLSEs were shown in FIG. 16. It reveal the coexistence of three crystalline phases: LNMO, LiF and Li₃PO₄. Li₃PO₄ was identified in the CEI by other studies and was considered to be a decomposition product of the LiDFP salt^{14, 15}.

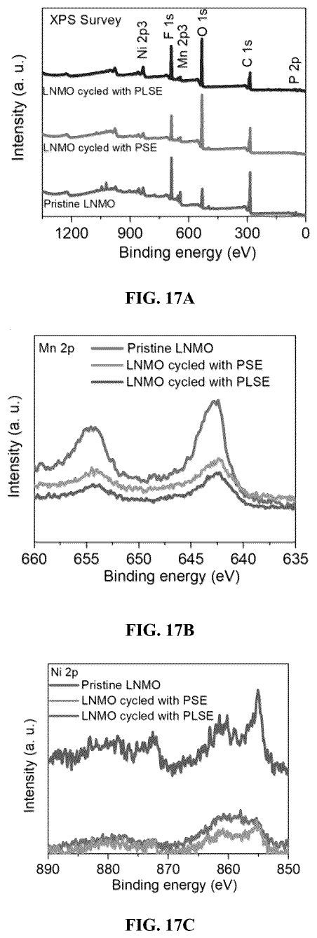

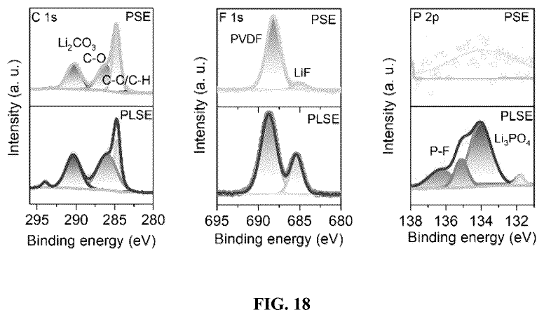

The present invention also conducted the ex-situ X-ray photoelectron spectroscopy (XPS) to analyze the chemical composition of the CEI on LNMO after one cycle. The relationship between CEI film and the structural stability of LNMO could be elaborated in the XPS survey (FIG. 17A), Mn 2p (FIG. 17B) and Ni 2p (FIG. 17C) spectra of the cathodes at fresh states, cycled with PSE and PLSE after 5 cycles at 0.5 C. There were no conspicuous changes in the valence states of the elements in LNMO, which proved the structural stability of LNMO could be maintained when being assembled with either PSE or PLSE. The C 1s spectra of the cathodes recovered from PLSE and PSE showed three pairs of peaks (FIG. 18), corresponding to Li₂CO₃, C—O and C—C/C—H, respectively.

Furthermore, a higher LiF concentration was detected in the CEI generated from PLSE when compared to that of PSE (FIG. 18). There were three peaks observed in the P 2p spectra of the cathode recovered from PLSE (FIG. 18), which were related to the P—F organic species and Li₃PO₄ produced from the decomposition of LiDFP at the cathode/electrolyte interface^{16, 17}.

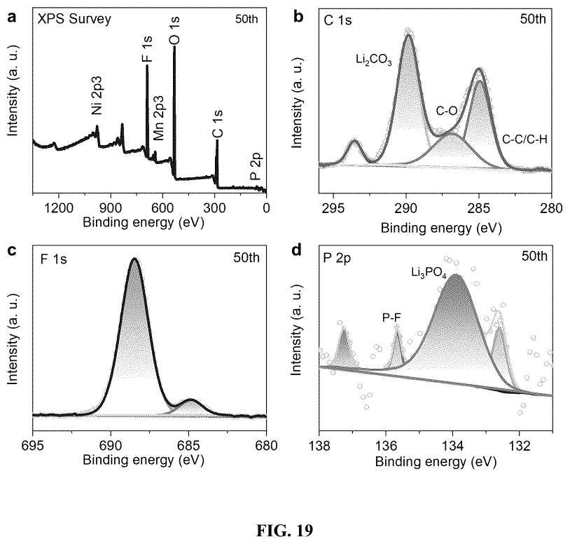

Li₃PO₄ possessed high ionic conductivity and a low interfacial barrier, contributing to fast ionic transport at the solid-solid interface¹⁸⁻²¹. It implied that the CEI comprised organic species, such as ROLi and ROCO₂Li²², and inorganic species including LiF, Li₃PO₄, and Li₂CO₃²²⁻²⁴. The LiDFP-derived CEI maintained similar content even after 50 cycles as it did during the initial formation process (FIG. 19(a)-19(d)), so this amorphous CEI had the ability to provide a durable interface for stable electrochemical reactions.

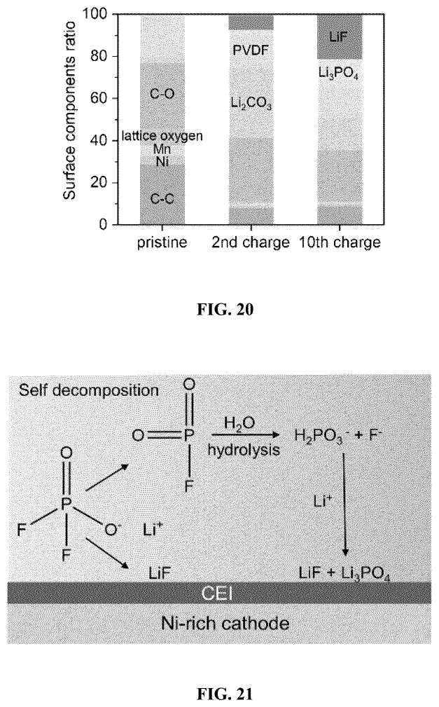

Quantitative analysis of XPS data was performed to make the decisive interpretation. The surface species (including CEI components, carbon additive etc.) on LNMO electrode and their relative amount at different states were shown in FIG. 20. The main CEI components on the LNMO cathode in a fully charged battery were Li₂CO₃, Li₃PO₄, LiF, and organic compounds containing C—O and C—H bonds²³. The increase in the amount of LiF and Li₃PO₄ in the CEI on the cathode surface indicated the formation of a robust CEI on the LNMO surface, promising to achieve stable operation of the full cells. These XPS results were in agreement with the ToF-SIMS and XRD results, illustrating that the CEI on LNMO with PLSE was composed of abundant Li₃PO₄ and LiF. The robust CEI was expected to enhance the cycling stability of LNMO. The CEI formation mechanism of PLSE was proposed in FIG. 21, where the decomposition of LiDFP resulted in positive components (Li₃PO₄ and LiF) and a negative component (HF, the attacker for the LNMO surface) at the SPE/electrode interface.

However, during the lithiation of LNMO cathode, Li⁺ would combine with HF to convert into LiF. Therefore, LiDFP had great potential to stabilize the LNMO cycling performance. The CEI could be divided into two parts: an inner CEI and an outer CEI. The inner CEI was most likely composed of Li₃PO₄ and LiF, while the outer CEI was most likely composed of organic oligomers resulting from the reactions between PLSE and LNMO cathodes, enhancing the interfacial compatibility.

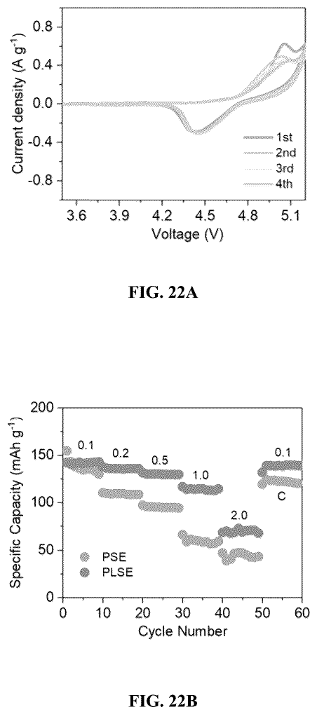

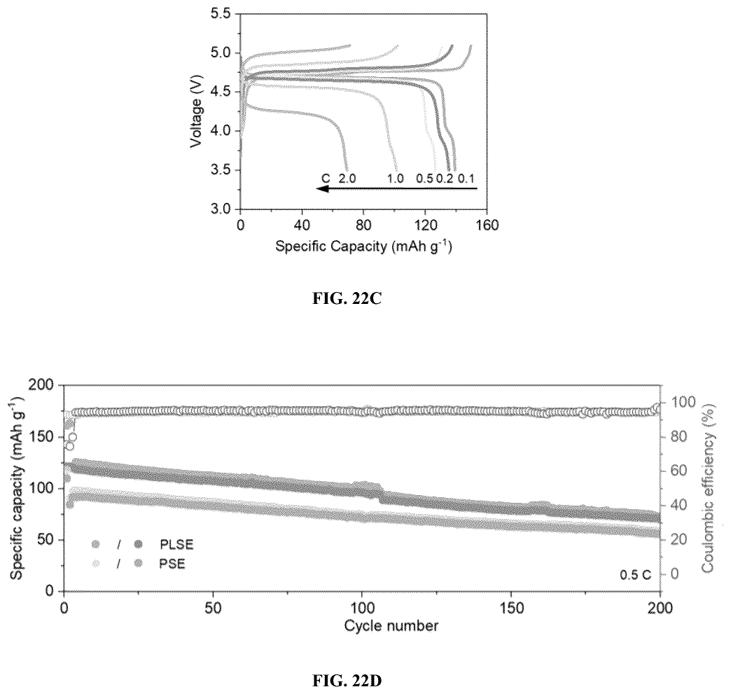

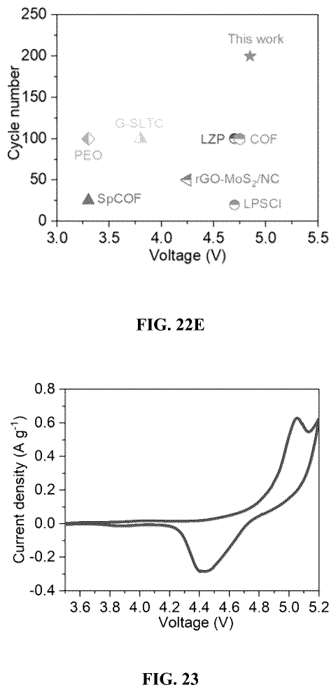

Considering the significance of a stable CEI formed by PLSE, the electrochemical performance of solid Li|LNMO batteries was evaluated by assembling them using a Li foil and a commercial LNMO cathode in conjunction with the PLSE. FIG. 22A displayed the cyclic voltammetry (CV) curves of LNMO with PLSE, in which a pair of intensity peaks at 4.9/4.5 V was assigned to Ni²⁺/Ni⁴⁺ redox couples. The considerable stability of the Li∥LNMO full cell with PLSE could be indicated according to the well-overlapped CV curves in subsequent cycles. However, the Li|PSE|LNMO full cell showed a higher polarization when compared to the Li|PLSE|LNMO full cell, revealing the more compatible property between PLSE and LNMO cathodes (FIG. 23).

### Example 7—Rate Performance of Solid Li|LNMO Cell Based on PLSE and PSE

As shown in FIG. 22B, the results indicated that as the current density increased stepwise, the cell with PLSE demonstrated better specific capacities compared to the cell using PSE. Li∥LNMO full cell with PLSE delivered decent specific capacities of 137, 130, 125, 105, and 70 mAh g⁻¹ recorded at 0.1, 0.2, 0.5, 1.0, and 2 C, respectively.

Notably, the corresponding galvanostatic charge-discharge (GCD) curves at various current densities for the Li∥LNMO full cell with PLSE were shown in FIG. 22C, displaying a discharge plateau at 4.7 V and a charge plateau of 4.75 V at 0.1 C, and the discharge/charge overpotential become larger as the rate increases.

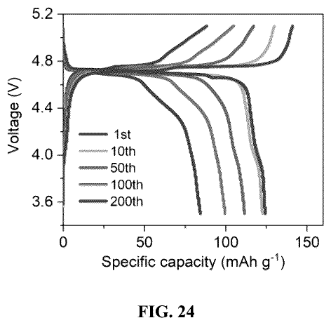

Moreover, the long-term cycling stability of the solid Li∥LNMO full cell with PLSE or PSE was tested at a current density of 0.5 C (as shown in FIG. 22D), with the corresponding selected GCD curves being presented in FIG. 24. The solid Li∥LNMO full cell with PLSE maintained a stable cycling lifespan of 200 cycles with high-capacity retention (75%), whereas the solid Li∥LNMO full cell with PSE experienced rapid capacity decay during cycling. The initial low coulombic efficiency observed for the solid Li∥LNMO full cell with PLSE was attributed to the formation of CEI induced by the interfacial reaction between PLSE and LNMO. This aspect held high significance for achieving excellent cycling durability.

The electrochemical performance of the solid Li∥LNMO full cell with the fabricated PLSE was markedly more outstanding than that of most of the previously reported counterparts that used different polymer matrices such as PVDF-HFP, PEO, and PAN, or had cathodes regulated by CEI (FIG. 22E)²⁵⁻³¹. All these results have demonstrated that the carefully designed PLSE with its CEI-regulated function could empower solid-state lithium-ion batteries (LIBs) with substantial capacity, impressive rate performance, exceptional stability, and extended cycling life, all achieved in a dendrite-free manner.

In summary, the present invention provides a novel design strategy of SPE to effectively widen the electrochemical window of SPEs up to 5.68 V, which is ascribed to the high antioxidant stability and CEI regulation function of the fabricated PLSE. The pyrolysis of LiDFP was responsible for the formation of CEI. Ex-situ XPS, HRTEM, and ToF-SIMS results revealed that the CEI primarily existed on the surface of LNMO particles. It exhibited a multilayer structure, comprising an inner CEI composed of durable LiF and Li₃PO₄, and an outer CEI composed of loosely bound organic oligomers. The establishment of a stable CEI on LNMO cathodes allows for excellent cycling stability, maintaining a lifespan of 200 cycles at 0.5 C with a high capacity retention of 75%. Furthermore, it exhibits remarkable rate performance, delivering substantial specific capacities of 137, 130, 125, 105, and 70 mAh g⁻¹ at 0.1, 0.2, 0.5, 1.0, and 2 C rates, respectively.

### Definitions

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

It will be appreciated by those skilled in the art, in view of these teachings, that alternative embodiments may be implemented without undue experimentation or deviation from the spirit or scope of the invention, as set forth in the appended claims. This invention is to be limited only by the following claims, which include all such embodiments and modifications when viewed in conjunction with the above specification and accompanying drawings.

### INDUSTRIAL APPLICABILITY

By integrating the superior stability of the PVTF polymer matrix and utilizing the pyrolysis of LiDFP, a high-performance PLSE has been successfully developed. The PLSE of the present invention exhibits advantageous characteristics such as an extended operational voltage window, cost-effectiveness, exceptional ionic conductivity, and the ability to regulate the formation of the solid electrolyte interphase (SEI) layer. The PLSE can work stably beyond 4.75 V, which is promising to increase the energy density of SSLIBs and demonstrating considerable potential in developing high-safety energy storage devices for applications such as large-scale stationary energy storage, portable electronics, flexible energy storage devices, and other related fields.

### REFERENCES: THE DISCLOSURES OF THE FOLLOWING REFERENCES ARE INCORPORATED BY REFERENCE

[1] X. Miao, H. Wang, R. Sun, C. Wang, Z. Zhang, Z. Li, L. Yin, Energy & Environmental Science 2020, 13, 3780.
[2] F. He, W. Tang, X. Zhang, L. Deng, J. Luo, Adv Mater 2021, 33, e2105329.
[3] J. Wu, L. Yuan, W. Zhang, Z. Li, X. Xie, Y. Huang, Energy & Environmental Science 2021, 14, 12.
[4] L. Han, L. Wang, Z. Chen, Y. Kan, Y. Hu, H. Zhang, X. He, Advanced Functional Materials 2023, 10.1002/adfm.202300892.
[5] S. Liu, W. Liu, D. Ba, Y. Zhao, Y. Ye, Y. Li, J. Liu, Adv Mater 2023, 35, e2110423.
[6] C. Wang, H. Liu, Y. Liang, D. Li, X. Zhao, J. Chen, W. Huang, L. Gao, L. Z. Fan, Advanced Functional Materials 2022, 33,
[7] B. Qiu, F. Xu, J. Qiu, M. Yang, G. Zhang, C. He, P. Zhang, H. Mi, J. Ma, Energy Storage Materials 2023, 60,
[8] Y. Chen, Y. Cui, S. Wang, Y. Xiao, J. Niu, J. Huang, F. Wang, S. Chen, Adv Mater 2023, 35, e2300982.
[9] X. Tang, X. Xu, M. Bai, M. Zhang, H. Wang, Z. Wang, A. Shao, H. Wang, Y. Ma, Advanced Functional Materials 2022, 33,
[10] K.-E. Kim, J. Y. Jang, I. Park, M.-H. Woo, M.-H. Jeong, W. C. Shin, M. Ue, N.-S. Choi, Electrochemistry Communications 2015, 61, 121.
[11] B. Yang, H. Zhang, L. Yu, W. Fan, D. Huang, Electrochimica Acta 2016, 221, 107.
[12] J. Tan, X. Li, Q. Li, Z. Wang, H. Guo, G. Yan, J. Wang, G. Li, Ionics 2022, 28, 3233. Y.-F. Huang, T. Gu, G. Rui, P. Shi, W. Fu, L. Chen, X. Liu, J. Zeng, B. Kang, Z. Yan, F. J. Stadler, L. Zhu, F. Kang, Y.-B. He, Energy & Environmental Science 2021, 14, 6021.
[14] S. Tan, Z. Shadike, J. Li, X. Wang, Y. Yang, R. Lin, A. Cresce, J. Hu, A. Hunt, I. Waluyo, L. Ma, F. Monaco, P. Cloetens, J. Xiao, Y. Liu, X.-Q. Yang, K. Xu, E. Hu, Nature Energy 2022, 7, 484.
[15] Z. Wang, F. Qi, L. Yin, Y. Shi, C. Sun, B. An, H. M. Cheng, F. Li, Advanced Energy Materials 2020, 10,
[16] S. Li, L. Yang, P. Wang, Z. Li, W. Li, H. Liu, X. Cui, Journal of Power Sources 2020, 471,
[17] X. Cui, J. Zhang, J. Wang, P. Wang, J. Sun, H. Dong, D. Zhao, C. Li, S. Wen, S. Li, ACS Appl Mater Interfaces 2021, 13, 59580.
[18] N. W. Li, Y. X. Yin, C. P. Yang, Y. G. Guo, Adv Mater 2016, 28, 1853.
[19] D. Zhao, S. Song, X. Ye, P. Wang, J. Wang, Y. Wei, C. Li, L. Mao, H. Zhang, S. Li, Applied Surface Science 2019, 491, 595.
[20] D. S. Hall, J. Self, J. R. Dahn, The Journal of Physical Chemistry C 2015, 119, 22322.
[21] J. Wang, D. Zhao, Y. Cong, N. Zhang, P. Wang, X. Fu, X. Cui, ACS Appl Mater Interfaces 2021, 13, 16939.
[22] H. J. Guo, H. X. Wang, Y. J. Guo, G. X. Liu, J. Wan, Y. X. Song, X. A. Yang, F. F. Jia, F. Y. Wang, Y. G. Guo, R. Wen, L. J. Wan, J Am Chem Soc 2020, 142, 20752.
[23] J.-N. Zhang, Q. Li, Y. Wang, J. Zheng, X. Yu, H. Li, Energy Storage Materials 2018, 14, 1.
[24] L. E. O. S. Verdier, R. Dedryvère, F. Bonhomme, P. Biensan, and D. Gonbeau, Journal of The Electrochemical Society 2007, 154, A1088.
[25] G. Lu, H. Wei, C. Shen, F. Zhou, M. Zhang, Y. Chen, H. Jin, J. Li, G. Chen, J. Wang, S. Wang, ACS Appl Mater Interfaces 2022, 14, 45476.
[26] L. L. Lu, Z. X. Zhu, T. Ma, T. Tian, H. X. Ju, X. X. Wang, J. L. Peng, H. B. Yao, S. H. Yu, Adv Mater 2022, 34, e2202688.
[27] S. Wang, X. Li, T. Cheng, Y. Liu, Q. Li, M. Bai, X. Liu, H. Geng, W.-Y. Lai, W. Huang, Journal of Materials Chemistry A 2022, 10, 8761.
[28] Y. Wang, Y. Lv, Y. Su, L. Chen, H. Li, F. Wu, Nano Energy 2021, 90,
[29] H. Xu, S. Wang, H. Wilson, F. Zhao, A. Manthiram, Chemistry of Materials 2017, 29, 7206.
[30] H. Zhao, Y. Ren, X. Bo, L. Si, Z. Wei, W. A. Daoud, Scripta Materialia 2023, 223,
[31] W. Zhao, M. Bai, S. Li, X. Tang, W. Wu, C. Sun, X. Yin, J. Zhou, S. Yuan, Y. Ma, Advanced Functional Materials 2019, 29,

What is claimed is:

1. A PVTF-based solid polymer electrolyte, comprising:
a polymer matrix;
a N, N-Dimethylformamide (DMF) solvent; and
lithium bis(trifluoromethanesulfonyl)imide (LiTFSI),
wherein the PVTF-based solid polymer electrolyte demonstrates an exceptional electrochemical window of up to 5.68 V, a significantly higher ionic conductivity of 1.91×10⁻³ S cm⁻¹ at ambient temperature, and the PVTF-based solid polymer electrolyte has a glass transition temperature (T_{g}) lower than −38° C.

2. The PVTF-based solid polymer electrolyte of claim 1, wherein the polymer matrix comprises PVTF with a mass of 0.1 g to 2 g, the LiTFSI has a mass of 0.1 g to 2 g and the DMF solvent has a volume of 1-10 mL.

3. The PVTF-based solid polymer electrolyte of claim 1, wherein the PVTF-based solid polymer electrolyte further comprises a sacrificial additive.

4. The PVTF-based solid polymer electrolyte of claim 1, wherein the sacrificial additive comprises lithium difluorophosphate (LiDFP) with a mass of 0.01-0.05 g.

5. A high-voltage solid-state lithium-ion battery with a wide electrochemical window of polymer electrolytes, comprising:
a cathode material;
an anode material;
a solid polymer electrolyte,
wherein the high-voltage solid-state lithium-ion battery has a consistent cycling performance over 200 cycles at 0.5 C, along with an impressive high-capacity retention of 75%.

6. The high-voltage solid-state lithium-ion battery of claim 5, wherein the cathode material comprises Ni-rich cathode material or lithium foil.

7. The high-voltage solid-state lithium-ion battery of claim 6, wherein the Ni-rich cathode material comprises spinel LiNi_{0.5}Mn_{1.5}O₄ (LNMO) particles.

8. The high-voltage solid-state lithium-ion battery of claim 7, there is an amorphous conductive CEI layer that encapsulates LNMO particles.

9. The high-voltage solid-state lithium-ion battery of claim 8, the CEI layer comprises an inner CEI and an outer CEI, and wherein the inner CEI comprises Li₃PO₄ and LiF.

10. The high-voltage solid-state lithium-ion battery of claim 8, wherein the cathode comprising LNMO particles with the CEI layer exhibits improved rate performance, yielding respectable specific capacities of 137, 130, 125, 105, and 70 mAh g⁻¹ recorded at 0.1, 0.2, 0.5, 1.0, and 2 C, respectively.

11. The high-voltage solid-state lithium-ion battery of claim 5, wherein the anode material comprises lithium foil.

12. The high-voltage solid-state lithium-ion battery of claim 5, wherein the anode and cathode further comprise a current collector, one or more active materials, one or more electronic conductive particles and one or more binders.

13. The high-voltage solid-state lithium-ion battery of claim 12, wherein the current collector comprises aluminum foil or copper foil.

14. The high-voltage solid-state lithium-ion battery of claim 5, wherein the high-voltage solid-state lithium-ion battery has a stable cycling lifespan of approximately 2400 hours at a current density of 0.1 mA cm⁻² with a capacity of 0.1 mAh cm⁻², demonstrating a very low overpotential of 55.7 mV.

15. The high-voltage solid-state lithium-ion battery of claim 5, wherein the high-voltage solid-state lithium-ion battery achieves a long cycle life of approximately 1600 hours when the current density increased to 0.5 mA cm⁻².
